(19) United States
(12) Patent Application Publication
(10) Pub. No.: US 2022/0072484 A1
(43) Pub. Date: Mar. 10, 2022

(54) CHITOSAN BASED MEMBRANE AND ASSOCIATED METHOD OF USE

(71) Applicant: University of South Florida, Tampa, FL (US)

(72) Inventor: Clifford Ronald Merz, Safety Harbor, FL (US)

(21) Appl. No.: 17/527,223

(22) Filed: Nov. 16, 2021

Related U.S. Application Data
(63) Continuation of application No. PCT/US2020/034223, filed on May 22, 2020.
(60) Provisional application No. 62/851,432, filed on May 22, 2019.

(51) Int. Cl. B01D 71/08; B01D 61/02; B01D 69/12; C02F 1/44; B01D 61/44; B01D 61/10; C02F 1/469; H01M 8/1025

(52) U.S. Cl. CPC B01D 71/08; B01D 61/025; B01D 69/12; C02F 1/441; C02F 2103/08; B01D 61/10; C02F 1/4693; H01M 8/1025; B01D 61/44

(57) ABSTRACT

A membrane comprising chitosan for use in Reverse Osmosis (RO) desalination, or for extracting economically valuable materials from seawater or another highly saline industrial fluid using a thin film composite (TFC) membrane porous support layer comprising chitosan, or for reducing the saline content of one or more industrial or mining fluids for hazardous waste disposal in operations such as desalinization or hydraulic fracturing fracking using a thin film composite (TFC) membrane porous support layer comprising chitosan. The chitosan-based membrane may also be used as part of a dialytic membrane electrode assembly for use in the generation and storing of low across membrane voltages and currents across a salinity concentration gradient.

### CROSS-REFERENCE TO RELATED APPLICATIONS

This application claims priority to and is a continuation of PCT International Patent Application No. PCT/US2020/034223, filed May 22, 2020 and entitled, “Chitosan Based Membrane and Associated Method of Use”, which claims priority to U.S. Provisional Patent Application No. 62/851,432, filed on May 22, 2019 and entitled, “Chitosan Based Membrane and Associated Method of Use”, the entirety of which are incorporated herein by reference.

### BACKGROUND OF THE INVENTION

Many industries are known to produce saline effluents, such as desalination plants, gas and oil drilling rigs, energy generating plants, various food manufacturing facilities and industries that require high volumes of water, such as hydraulic fracking and the textile industry. To diminish the negative environmental impact of direct discharge of the saline effluents into water bodies (e.g. groundwater, lakes, rivers, the oceans) the high salt concentration of the effluents resulting from these processes needs to be reduced, prior to discharge into the environment.

Membrane-based processes for the treatment of the saline effluents are known in the art to include pressure retarded reverse osmosis (PRO) and reverse electrodialysis (RED), where a significant driving force in the industrial development of membranes already exists. PRO and RED utilize the electrochemical properties of solutions of differing saline concentrations (salinity) separated by semipermeable and/or charged ion-exchange membranes to accomplish Salinity Gradient Power (SGP) energy generation.

Most of the carbohydrates found in nature occur as polysaccharides, polymers of high molecular weight. Chitin is a naturally occurring biopolymer with great potential for industrial use because of its high amine content and polycatonic nature. Chitin is a linear homopolymer (a polymeric carbohydrate molecule with repeating units of a single monomeric unit), containing residues of the monosaccharide N-acetyl-D-glucosamine joined by β(1→4) linkage. Chitin occurs mainly as the principal element in the hard exoskeletons, inner shell or cell wall of invertebrates, fungi and yeasts and is the second most abundant naturally occurring polymer on earth after cellulose.

Chitin is the most abundant natural polymer in the ocean and thereby provides an enormous reservoir of organic carbon and nitrogen to draw from. Global fisheries contribute significantly to satisfying the world's need for protein. However, crustacean and cephalopod seafood processing can generate between 35 to 75% bio-waste by weight consisting of the shell, head, and viscera. With increasing demands in both human population and protein needs, continued improvements in sustainable seafood bio-waste management, through new market development, is essential

Accordingly, what is needed in the art is an improved membrane that addresses the need for continued improvements in bio-waste management.

### BRIEF SUMMARY OF THE INVENTION

Chitosan membranes possess a high water flux permeability when subjected to a difference in salinity gradient concentration. In various embodiments, the present invention utilizes a chitosan membrane as a thin film composite (TFC) membrane porous support layer for membrane filtration applications such as Reverse Osmosis (RO) desalinization, for the extraction of economically valuable materials from seawater or highly saline industrial fluids and for the reduction in the saline content of industrial and/or mining fluids for hazardous waste disposal in operations such as desalinization or hydraulic fracturing fracking. The present invention additionally proposes the use of membranes comprising chitosan for applications including batteries, capacitors and fuel cells for uses inside the human body where natural ion-exchange conditions are low across membrane voltages and current exist.

In one embodiment, the present invention provides a membrane comprising chitosan, the membrane having a high water and ion flux permeability under a salinity concentration gradient. In a particular embodiment the chitosan may have a degree of deacetylation (DDA) greater than about 90% and the % composition of chitosan in the membrane may be about 2%.

The chitosan for use in the membrane is non-ion selective and may be α-chitosan, β-chitosan or γ-chitosan.

In a particular embodiment, the membrane may be used as a micro porous support layer of a thin film composite (TFC) membrane. The TFC membrane may be used in a Reverse Osmosis (RO) desalinization process or to recover economically valuable materials from a highly concentrated saline solution seawater or another highly saline industrial fluid under the salinity concentration gradient. The highly concentrated saline solution may be seawater or one of many other highly saline industrial fluids, including fluid from mining operations for hazardous waste disposal and from the hydraulic fracking of water. As such, the RO process using the TFC membrane having chitosan is effective in reducing the saline content of a highly concentrated saline solution.

In another embodiment, the chitosan-based membrane may be used as the membrane in a dialytic membrane electrode assembly for a Salinity Gradient Power (SGP) energy generation system.

The present invention additionally provides a method for performing Reverse Osmosis (RO) of saltwater, which includes, positioning a thin film composite (TFC) membrane comprising chitosan as a porous layer under a salinity concentration gradient, wherein the chitosan has a degree of deacetylation (DDA) greater than about 90%, to perform RO of the saltwater. The chitosan may be α-chitosan, β-chitosan or γ-chitosan and the % composition of the chitosan in the membrane may be approximately 2%.

The desalination process may be used for the desalination of saltwater or for accumulating one or more economically valuable materials from the saltwater.

In another embodiment, the present invention provides a method for Salinity Gradient Power (SGP) generation, which includes, positioning an ion semi-permeable membrane comprising chitosan across a salinity concentration gradient to generate power. The chitosan may be α-chitosan, β-chitosan or γ-chitosan and the % composition of the chitosan in the membrane may be approximately 2%.

### BRIEF DESCRIPTION OF THE DRAWING

For a fuller understanding of the invention, reference should be made to the following detailed description, taken in connection with the accompanying drawings, in which:

FIG. 1 illustrates a short segment of cellulose, chitin, and chitosan structure.

FIG. 2 illustrates an FTIR spectra of Alpha (Shrimp) and Beta (Squid) 2% chitosan membranes.

FIG. 3 illustrates an ICP-MS vs. Potentiometric Titration—Chloride Ion Testing Method Comparison.

FIG. 4 illustrates a measured water transport and Cl-ion diffusion across a 2% β-chitosan membrane.

FIG. 5A is a graphical illustration of the Element Specie Concentration of Na and Cl transported across the Alpha and Beta 2% chitosan membranes—Multi-Run Summary (M) DI/Full Brine.

FIG. 5B is a graphical illustration of the Element Specie Concentration of K, Mg, Ca, B, and Br transported across the Alpha and Beta 2% chitosan membranes—Multi-Run Summary (mM) DI/Full Brine. Run B1-17 value for B removed as Outlier.

FIG. 5C is a graphical illustration of the Element Specie Concentration of Li, Sr, and Rb transported across the Alpha and Beta 2% chitosan membranes—Multi-Run Summary (μM) DI/Full Brine

FIG. 5D is a graphical illustration of the Element Specie Concentration of Na and Cl transported across the Alpha and Beta 2% chitosan membranes—Single/Multi-Run Summary (M) DI/1:10 Brine. Run B2-11 value for Na removed as Outlier

FIG. 5E is a graphical illustration of the Element Specie Concentration of K, Mg, Ca, B, and Br transported across the Alpha and Beta 2% chitosan membranes—Single/Multi-Run Summary (mM) DI/1:10 Brine. Run B2-11 values for K, Ca removed as Outlier

FIG. 5F is a graphical illustration of the Element Specie Concentration of Li, Sr, and Rb transported across the Alpha and Beta 2% chitosan membranes—Single/Multi-Run Summary (μM) DI/1:10 Brine. Run B2-11 values for Sr, Rb removed as Outlier

FIG. 6A illustrates SEM Low Resolution (10,000×) Image of 2% Alpha chitosan membrane. Scale bar: 5 μm

FIG. 6B illustrates SEM High Resolution (50,000×) Image of 2% Alpha chitosan membrane. Scale bar: 1 μm

FIG. 6C illustrates SEM Low Resolution (10,000×) Image of 2% Beta chitosan membrane. Scale bar: 5 μm.

FIG. 6D illustrates SEM High Resolution (50,000×) Image of 2% Beta chitosan membrane. Scale bar: 1 μm.

### DETAILED DESCRIPTION OF THE INVENTION

Few biological polymers possess as high a number of amino groups as chitin, which lead to, increased strength of the chitin-polymer matrix, increased hydrogen bonding between adjacent polymer layers and high adsorption properties leading to effective ion exchange capabilities. Serving as a natural structural biopolymer, chitin and its derivative chitosan, possess many interesting properties including unique crystalline structures, multidimensional properties, and nontoxicity and biodegradability in both the solution and solid-state phases. Like cellulose, chitin is indigestible by vertebrate animals and forms extended fibers.

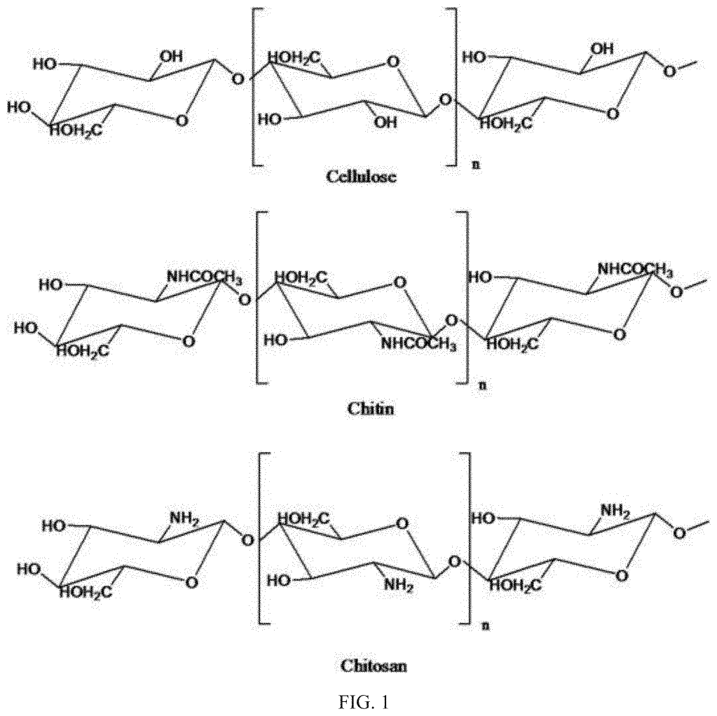

Chitin is not soluble in ordinary solvents. As shown in FIG. 1, Chitin differs from cellulose within the glucose unit where one hydroxyl group (—OH) is replaced at the C-2 position with one acetylated amino group (NHCOCH₃). Chitosan, derived from chitin by deacetylation, differs from chitin by the converted amine group (free—NH₂) which imparts a hydrophilic and polycatonic nature to the chitosan product, enabling its solubility in dilute organic acidic solutions where the pH is <6.6. Chitin exists in three different crystalline structural/polymorphic forms, referred to as α-, β-, and γ-chitin which differ in their degree of hydration, size of the unit cell and number of chitin chains per cell. α-chitin, the most common polymorphic form found in commercial chitin and chitosans, is frequently obtained from the large amount of available low-cost marine crustacean (e.g. lobsters, crabs, and shrimp) bio-waste. β-chitin is also available in reduced quantities from marine cephalopods (squid pen) bio-waste but can be obtained from other marine sources such as the crystalline fibrils of some microalgae (diatoms) and the tubes of vestimentiferans (giant undersea tube worms). γ-chitin is usually obtained from fungi and yeasts with the crystalline structure being a combination of the α- and β-forms. Chitin is highly acid resistant, and chitosan is highly alkaline resistant. These characteristics, that depending upon the end use application, can lend themselves well for use in separation membrane applications.

The —OH and —NH₂ functional groups in chitosan facilitate an adsorbent function which has lent itself to numerous investigations as an adsorbent for the treatment of wastewater and the removal of heavy metals from liquid effluents and natural water by biosorption. The sorption capacity of chitin and chitosan materials depends on the origin of the polysaccharide, molecular weight (M), degree of N-acetylation, solution properties, and varies with crystallinity, affinity for water, and amino group content.

α—chitin has a very stable unit cell intra-chain, intra-sheet, and inter-sheet hydrogen bonds forming from antiparallel crystalline sheets, whereas, the β-chitin unit cell consists of parallel sheets with weaker hydrogen bonds between two inter-sheets and reduced intra-sheet attraction. These structural changes lead to higher solubility, reactivity, and swelling ability towards solvents of β-chitin than α-chitin after alkali treatments which could alter the chitosan solution conformations and impact their antibacterial activity.

Owing to its unique crystalline structural arrangement, it has been reported that β-chitin more readily accepts intercalated water molecules than α-chitin. With the intra-crystalline swelling of β-chitin strongly anisotropic without modifications to the β-chitin sheets that are maintained by strong N—H . . . O═C intermolecular hydrogen bonds. Considering the reported intercalation of water molecules within its crystalline lattice and weaker intermolecular hydrogen bonding between sheets of parallel chains, β-chitin may possess differing and enhanced performance characteristics than α-chitin, with respect to diffusive water flux and ionic transport capabilities.

In various embodiments, the present invention provides a comparison of α-, β-chitin to investigate and report on select physicochemical, colligative, and microstructural characteristics needed to substantiate the hypothesis of differing diffusive ion-transport and osmotic flow capabilities. The present invention additionally advances the multi-faceted synergistic goal of bio-waste management improvement and new market development by extending the consideration of possible chitosan biopolymer membrane uses to developing and sustainable technologies such as Salinity Gradient Power generation and Industrial Separation Process Operations.

Chitosan's physicochemical, rheological, and physical properties vary significantly as a function of its molecular weight characterization. The analytical technique frequently cited in the literature for the determination of chitosan's molar mass distributions; number-average molecular weight (Mₙ), weight-average molecular weight (M_{w}) distribution, and polydispersity (P_{D}=M_{w}/Mₙ), is aqueous Gel Permeation Chromatography (GPC) Size Exclusion Chromatography (SEC). Knowledge of Mₙ is important for thermal properties (e.g. Glass transition, T_{g}), and M_{w} for tensile strength and impact resistance (i.e. mechanical properties)

Chitin is insoluble in water and common organic solvents and is usually converted to chitosan (deacetylated form of chitin) for use, with the extractability and degree of deacetylation (DDA, %) dependent upon the conversion process used. When the % DDA approaches 50%, chitin becomes soluble in aqueous acidic solution through the protonation of the NH₂ group and become chitosan. The presence of both amino and hydroxyl groups provides the chitosan macromolecule unique properties. Including being easily dissolved in aqueous acetic acid of low concentrations and possessing a hydrophilic property which lends to solvent stability and water swelling.

In an exemplary embodiment, chitosan biopolymer membranes were prepared from shrimp shell (α-chitin) and squid pen (β-chitin) chitosan powder by solvent casting after which Physicochemical testing and Colligative water flux and ionic transport diffusion experiments were conducted using synthetic seawater in a side-by-side concentration test cell under differing salinity concentration gradients. Diffusion is the spontaneous, net movement of molecules of a substance from a region of high concentration to one of low concentration. Since the molecules are in thermal random motion, there will be more molecules moving from the high concentration region to the low concentration region, than in the opposite direction. There is no special force on the individual molecules and as such, diffusion is purely a consequence of statistics.

The functionality of linear polymers, such as chitosan, is highly affected by the % DDA and polymer size obtained during the conversion process. Typically, chitosan is obtained by the partial deacetylation of chitin in hot concentrated aqueous alkali (typically 40-50% NaOH for several hours) at 100-160° C. for α-chitosan and at 80° C. for β-chitosan. This hydrolysis step removes some of the acetyl groups, resulting in differing amounts of acetylated units of N-acetyl-D-glucosamine (GlcNAc) and deacetylated units of D-Glucosamine (GlcN). The % DDA is defined as the molar fraction of GlcN units in the copolymer (chitosan) which is composed of GlcNAc and GlcN units. When the majority of GlcNAc units are converted to GlcN units (high % DDA), the polymer becomes highly soluble in dilute acids.

Examination of the measured FTIR spectra can provide useful insight into the molecular characteristics as well as reveal any observed changes in the chemical bonds. % DDA was computed from the measured spectral data using Equation 1 and compared to the vendor supplied data, where A₁₆₅₅ and A₃₄₅₀ were the measured absorbance at 1,655 cm⁻¹ (amine group) and 3,450 cm⁻¹ (hydroxyl [OH] group), respectively.

$$\% DDA = {A}_{1655} / {A}_{3450} \times 115 \qquad Equation 1$$

Using Equation 1, the computed FTIR % DDA values vs. Vendor supplied values are:
Shrimp (α): FTIR=89% DDA; Vendor=88% DDA
Squid (β): FTIR=86% DDA; Vendor=91.7% DDA

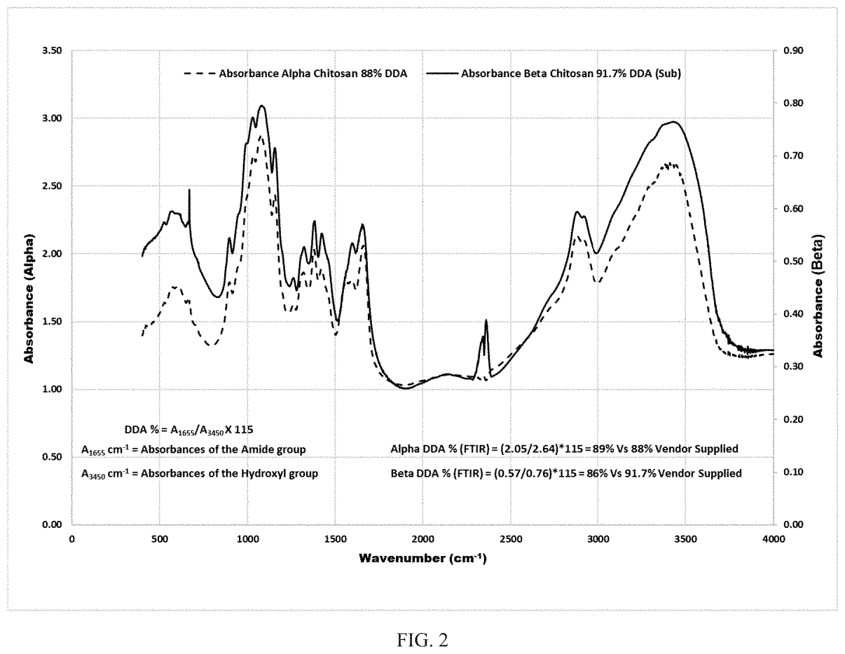

With reference to FIG. 2, the region between 2,800 cm⁻¹ and 2,900 cm⁻¹ corresponds to vibration of CH stretching, assuming the free hydroxymethyl (CH₂OH) groups dissociated from hydrogen bonds. The band at 1,375 cm⁻¹, resulting from the C—H bond in the acetamide group, indicates that the chitin samples were not completely deacetylated. The spectrum region between 3000 and 3600 cm⁻¹ attributed to the vibration of either OH or NH, indicating the hydrogen bonds appeared in C(6)OH . . . O═C, C(3)OH . . . O, C(6)OH . . . OHC(3), C(2)NH . . . O═C, and C(6)HO . . . HNC(2). Close review of FIG. 2 reveals a similar spectral shape for both the α- and β-chitosan samples, with an overall increase observed in the β-chitosan sample corresponding to the regions pertaining to expected intra-sheet and/or inter-sheet hydrogen bond and CH stretching.

The source of the band in the β-chitosan spectra between 2,300 and 2,380 cm⁻¹ is unknown

GPC/SEC is a liquid chromatography technique that separates macromolecules by their size in solution. Aqueous GPC-SEC separation is based upon differential migration between the stationary and mobile phases and governed by the hydrodynamic size and shape of the polymer chains relative to the size and shape of the porous pores within the column packing material. Summary data obtained from the aqueous GPC-SEC testing effort are presented in Table 1.

TABLE 1
Average GPC Sample Analysis of Sampled Alpha (α) and Beta (β) chitosan.

| | Mₙ | Pd | | η | | Alpha | LogK |
|---|---|---|---|---|---|---|---|
| Sample | (kDa)^{a} | (M_{w}/Mₙ)^{b} | RII ^{c} | (dL/g) ^{d} | Rh (nm) ^{e} | Exponent ^{f} | Constant ^{f} |
| Shrimp | 171.556 | 2.939 | 0.126 | 2.8718 | 23.85 | 0.558 | −2.509 |
| (α) | | | | | | | |
| Squid | 66.950 | 2.840 | 0.170 | 3.2905 | 19.27 | 0.722 | −3.218 |
| (β) | | | | | | | |

^{a}Number-Average molecular weight measured by gel permeation chromatography(GPC) using a mixture of 0.1M acetic acid and 0.3M sodium nitrate in HPLC grade water as the mobile phase at 35° C.
^{b}Poly-dispersity (M_{w}/Mₙ).
^{c} Refractive Index Increment (dn/dc) where values were calculated by assuming 100% mass injection recovery of the triplicate injections.
^{d} Intrinsic Viscosity.
^{e} Hydro-dynamic radius.
^{f} Mark-Houwink.

In accordance with an exemplary procedure outlined below, α- and β-chitosan membrane test samples were made with the following casting constituents:
Shrimp (α): DI=100 ml; Glacial Acetic Acid=1 ml; Glycerol=0.7 g; Chitosan=2.02 g.
Squid (β): DI=100 ml; Glacial Acetic Acid=1 ml; Glycerol=0.7 g; Chitosan=2.02 g.

Resulting in a % Chitosan composition of nominally 2% (1.95%) α- and β-membranes prepared and evaluated.

Instant Ocean® Synthetic Sea Salt was used throughout this testing effort to provide a suitable medium without the deleterious effects of marine biofouling. The concentrated ionic test solution (Full Brine) was made from 300 grams of Instant Ocean® Sea Salt dissolved in enough DI water to make 1 liter of total solution. The dilute ionic test solution (1:10 Brine) was made by serially diluting 100 ml of the Full Brine solution to 1 liter with DI water. Runs consisted of either Full Brine or 1:10 Brine solution in the concentrated test cell chamber side and DI water in the dilute test cell chamber side. A summary of test configurations for each test solution type used in this analysis along with the measured electrically “loaded” cell potential voltage at osmotic equilibrium is presented in Table 2.

TABLE 2
Salinity Gradient Concentration Cell Test Run Summary.

| Test | Test | Membrane Type and | |
|---|---|---|---|
| Sample | Sample | Nominal Loaded Voltage | |
| Number | Name | Potential | Test Solution Type |
| 1 | A4-2 | α-chitosan (V = 0.6 mV) | Full Brine/DI - dilute test side |
| 2 | A5-3 | α-chitosan (V = 0.6 mV) | 1:10 Brine/DI - dilute test side |
| 3 | A5-4 | α-chitosan (V = 0.6 mV) | 1:10 Brine/DI - concentrated test side |
| 4 | A7-1 | α-chitosan (V = 0.6 mV) | Full Brine/DI - dilute test side |
| 5 | A7-2 | α-chitosan (V = 0.6 mV) | Full Brine/DI - concentrated test side |
| 6 | B1-3 | β- chitosan (V = 0.6 mV) | Full Brine/DI - dilute test side |
| 7 | B1-6 | β- chitosan (V = 0.6 mV) | 1:10 Brine/DI - dilute test side |
| 8 | B1-8 | β- chitosan (V = 0.6 mV) | 1:10 Brine/DI - dilute test side |
| 9 | B1-9 | β- chitosan (V = 0.6 mV) | 1:10 Brine/DI - concentrated test side |
| 10 | B1-10 | β- chitosan (V = 0.6 mV) | Full Brine/DI - dilute test side |
| 11 | B1-11 | β- chitosan (V = 0.6 mV) | Full Brine/DI - concentrated test side |
| 12 | B1-14 | β- chitosan (V = 0.6 mV) | Full Brine/DI - dilute test side |
| 13 | B1-16 | β- chitosan (V = 0.6 mV) | Full Brine/DI - dilute test side |
| 14 | B1-17 | β-chitosan (V = 0.6 mV) | Full Brine/DI - dilute test side |
| 15 | B2-1 | β- chitosan (V = 0.6 mV) | Full Brine/DI - dilute test side |
| 16 | B2-3 | β- chitosan (V = 0.6 mV) | 1:10 Brine/DI - dilute test side |
| 17 | B2-8 | β- chitosan (V = 0.6 mV) | 1:10 Brine/DI - dilute test side |
| 18 | B2-11 | β- chitosan (V = 0.6 mV) | 1:10 Brine/DI - dilute test side |
| 19 | B1-2 | — | Standard - Full Brine |
| 20 | B1-5 | — | Standard - 1:10 Brine |
| 21 | A1 | — | Standard - DI |
| 22 | BP-1 | BPM (V = 1.14 mV) | Full Brine/DI - dilute test side |
| 23 | BP-2 | BPM (V = 1.14 mV) | Full Brine/DI - concentrated test side |
| 24 | BP-5 | BPM (V = 0.6 mV) | 1:10 Brine/DI - dilute test side |
| 25 | BP-6 | BPM (V = 0.6 mV) | 1:10 Brine/DI - concentrated test side |

Samples obtained from the concentration test cell were analyzed using Inductively Coupled Plasma Mass Spectrometry (ICP-MS) instrumentation. To verify the applicability of the ICP-MS anion measurements for future use in the calculation of total osmotic pressure, a separate Cl⁻ ion titration was done on each of the solution test samples for comparison. Discussion of both are presented herein.

Seawater contains dissolved salts at a total ionic concentration of approximately 1.12 mol L⁻¹ (M) and a computed osmotic pressure at 25° C. of 27.2 atm. A salt is an electrically neutral ionic compound comprised of two oppositely charged ions; cations and anions. When a salt dissolves in water, it dissociates into its individual cations and anions. Seawater is nominally 86% sodium chloride (NaCl) with Na⁺ and Cl⁻ almost completely dissociated. Every naturally occurring element that can be found on earth has been found dissolved in seawater. However, although present in measurable concentrations, there is a great variation in the concentration magnitudes of the ions present. According to chemical oceanographic convention, a concentration criterion of one part in a million (1 ppm or 1 mg/kg) has been established as the separation point. Elements with higher dissolved concentrations are referred to as major constituents and those below as minor constituents. These major ions are termed “conservative”, meaning that they occur in constant ratios to each other in almost all ocean (sea) water. As defined, there are 11 substances considered as major constituents: Na⁺, Mg²⁺, Ca²⁺, K⁺, Sr²⁺, Cl⁻, SO₄²⁻, HCO₃⁻, Br⁻, F⁻, and B(OH)₃. Na⁺, Mg²⁺, Ca²⁺, K⁺, Cl⁻, and SO₄²⁻ make up >99% of the total dissolved constituents in seawater.

The ICP-MS is mainly used for elemental analysis of cations. Sulfate (SO₄²⁻) and bicarbonate (HCO₃⁻) are polyatomic ions (not elemental) and are very difficult to measure with ICP-MS because the base elements of those ions, sulfur and carbon, along with fluorine, naturally form anions. Samples were initially run on an ICP-MS in semi-quantitative mode to identify what elements were present at concentrations that were easily measurable. The following 10 elements were mainly present: Na, Mg, Ca, K, Sr, Cl, Br, B, Li and Rb. Of these Na, Mg, Ca, K, Sr, Cl, Br, and B make up 8 of the 11 major elements found in seawater. The remaining 2 elements (Li and Rb) are considered minor constituents in seawater but were included with the other 8 in subsequent quantitative analyses because they are present at high enough concentrations to be easily measured by ICP-MS and are of frequent interest in seawater and seawater brine element recovery studies. Measured ICP-MS sample test results are presented in Table 3.

TABLE 3
ICP-MS Test Sample Measured Ion Concentration Results Run Summary.

| | Li⁺¹ | Na⁺¹ | Mg⁺² | K⁺¹ | Ca⁺² | Rb⁺¹ | Sr⁺² | B⁺³ | Cl⁻¹ | Br⁻¹ |
|---|---|---|---|---|---|---|---|---|---|---|
| Run | (μM) | (M) | (mM) | (mM) | (mM) | (μM) | (μM) | (mM) | (M) | (mM) |
| A4-2 | 231.667 | 1.981 | 212.343 | 37.981 | 11.443 | 2.910 | 370.920 | 1.462 | 2.140 | 4.219 |
| A5-3 | 15.963 | 0.141 | 14.742 | 2.747 | 0.835 | 0.217 | 27.231 | 0.151 | 0.166 | 0.317 |
| A5-4 | 15.315 | 0.118 | 21.099 | 2.035 | 1.045 | 0.161 | 35.152 | 0.182 | 0.149 | 0.284 |
| A7-1 | 189.454 | 1.729 | 178.166 | 38.740 | 10.421 | 2.451 | 312.219 | 1.357 | 2.145 | 4.426 |
| A7-2 | 196.898 | 1.690 | 248.029 | 34.750 | 14.184 | 2.246 | 455.718 | 2.433 | 2.210 | 4.414 |
| B1-3 | 194.064 | 2.168 | 168.031 | 47.930 | 8.379 | 3.058 | 307.806 | 1.485 | 2.306 | 2.862 |
| B1-6 | 15.488 | 0.183 | 12.977 | 4.294 | 0.697 | 0.256 | 26.181 | 0.176 | 0.227 | 0.391 |
| B1-8 | 13.910 | 0.174 | 10.944 | 4.235 | 0.640 | 0.255 | 22.552 | 0.149 | 0.212 | 0.338 |
| B1-9 | 16.266 | 0.178 | 19.383 | 3.744 | 0.990 | 0.229 | 37.001 | 0.197 | 0.212 | 0.370 |
| B1-10 | 182.635 | 2.099 | 159.419 | 46.464 | 8.261 | 2.857 | 292.171 | 1.330 | 2.440 | 3.467 |
| B1-11 | 184.892 | 2.051 | 203.401 | 42.781 | 10.548 | 2.688 | 401.088 | 1.950 | 2.336 | 3.261 |
| B1-14 | 190.318 | 2.162 | 166.550 | 47.598 | 8.870 | 2.989 | 307.236 | 1.488 | 2.306 | 2.906 |
| B1-16 | 154.589 | 2.081 | 160.420 | 49.746 | 13.803 | 3.126 | 326.866 | 1.424 | 2.455 | 3.019 |
| B1-17 | 159.775 | 2.047 | 144.826 | 48.365 | 10.460 | 3.057 | 291.714 | 1.149 | 2.455 | 3.390 |
| B2-1 | 202.997 | 2.078 | 133.800 | 45.296 | 7.465 | 2.888 | 281.899 | 1.393 | 2.319 | 2.808 |
| B2-3 | 12.828 | 0.158 | 9.298 | 3.880 | 0.569 | 0.236 | 19.664 | 0.146 | 0.194 | 0.281 |
| B2-8 | 15.790 | 0.167 | 9.089 | 3.742 | 1.182 | 0.235 | 26.592 | 0.142 | 0.195 | 0.267 |
| B2-11 | 17.533 | 0.208 | 16.404 | 4.926 | 2.369 | 0.300 | 41.315 | 0.225 | 0.268 | 0.443 |
| B1-2 | 315.949 | 3.703 | 345.731 | 76.448 | 15.799 | 4.719 | 646.998 | 3.874 | 3.766 | 6.607 |
| B1-5 | 31.465 | 0.358 | 33.503 | 7.430 | 1.646 | 0.466 | 64.574 | 0.389 | 0.425 | 0.672 |
| A1 | 0.000 | 0.000 | 0.016 | 0.000 | 0.000 | 0.001 | 0.016 | 0.000 | 0.000 | 0.000 |
| BP-1 | 4.303 | 0.048 | 0.454 | 1.371 | 0.072 | 0.073 | 1.006 | 0.012 | 0.058 | 0.097 |
| BP-2 | 321.567 | 3.395 | 296.194 | 69.312 | 16.528 | 4.530 | 666.172 | 3.180 | 3.771 | 6.428 |
| BP-5 | 0.340 | 0.003 | 0.005 | 0.124 | 0.016 | 0.004 | 0.095 | 0.012 | 0.004 | 0.004 |
| BP-6 | 31.033 | 0.332 | 31.463 | 7.044 | 1.740 | 0.458 | 63.604 | 0.399 | 0.403 | 0.533 |

The ICP-MS is mainly used for elemental analysis of cations. Sulfate (SO42-) and Back-up concentration cell water sample Cl⁻ ion titration testing began by serially diluting 1 ml of test sample to 100 ml with DI water and then adding it to a 250 ml beaker with magnetic stirring. Both electrodes were immersed in the solution and agitation began. Silver nitrate (AgNO₃) was then added in 0.5 mL increments and both the volume of the titrant added, and the multi-meter value recorded on a spreadsheet after each addition. Using the acquired data, a second order differential potential curve was plotted to determine the titration end point and corresponding total volume of AgNO₃ (V_{AgNO3}) which was used along with the molarity (molar concentration) of the AgNO₃ titrant (C_{AgNO3}) (0.1 N for Full Brine based samples or 0.01 N for 1:10 Brine based samples or less) and the original test sample volume (V_{Cl}_{^{−}}) to determine the desired Cl⁻ molarity present (C_{Cl}_{^{−}}) in the test sample according to Equation 2:

$${C}_{{Cl}^{-}} = ( {C}_{A g N O 3} {V}_{A g N O 3} ) / {V}_{{Cl}^{-}} \qquad Equation 2$$

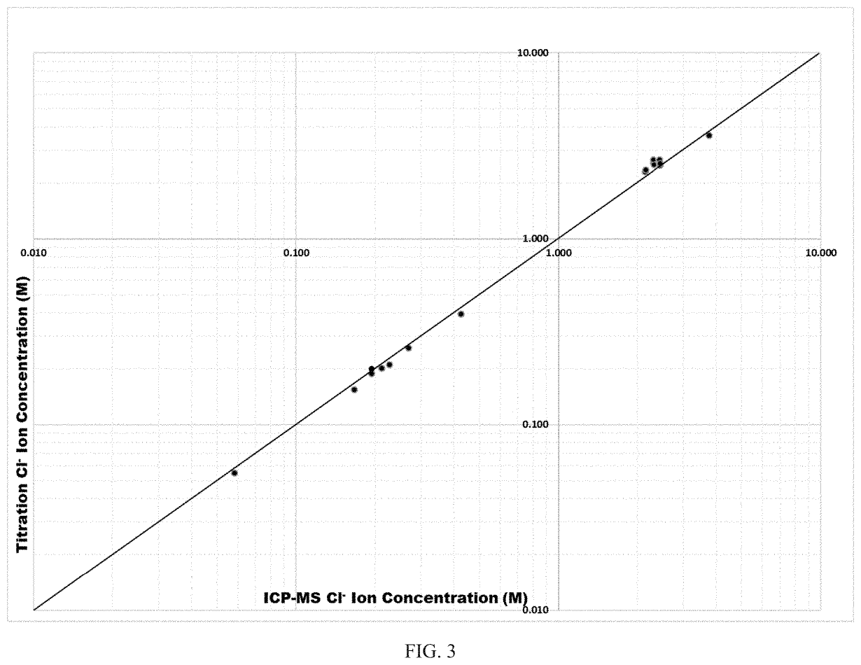

Data obtained from both the Cl⁻ ion potentiometric titration (C_{Cl}_{^{−}}) and the ICP-MS testing are presented in Table 4 with the results displayed in FIG. 3.

TABLE 4
Salinity Gradient Concentration Cell Test Run Summary.

| | | | | | Measurement |
|---|---|---|---|---|---|
| | Membrane | Test Solution | ICP-MS | Titration | Difference |
| Run | Type | Type | Cl⁻ (M) | Cl⁻ (M) | Between % |
| A4-2 | α-chitosan | Full Brine/DI | 2.140 | 2.293 | −7 |
| A5-3 | α-chitosan | 1:10 Brine/DI | 0.166 | 0.154 | 7 |
| A7-1 | α-chitosan | Full Brine/DI | 2.145 | 2.352 | −10 |
| B1-3 | β-chitosan | Full Brine/DI | 2.306 | 2.568 | −11 |
| B1-6 | β-chitosan | 1:10 Brine/DI | 0.227 | 0.210 | 8 |
| B1-8 | β-chitosan | 1:10 Brine/DI | 0.212 | 0.201 | 5 |
| B1-10 | β-chitosan | Full Brine/DI | 2.440 | 2.650 | −9 |
| B1-14 | β-chitosan | Full Brine/DI | 2.306 | 2.654 | −15 |
| B1-16 | β-chitosan | Full Brine/DI | 2.455 | 2.489 | −1 |
| B1-17 | β-chitosan | Full Brine/DI | 2.455 | 2.551 | −4 |
| B2-1 | β-chitosan | Full Brine/DI | 2.319 | 2.502 | −8 |
| B2-3 | β-chitosan | 1:10 Brine/DI | 0.194 | 0.188 | 3 |
| B2-8 | β-chitosan | 1:10 Brine/DI | 0.195 | 0.198 | −2 |
| B2-11 | β-chitosan | 1:10 Brine/DI | 0.268 | 0.259 | 3 |
| B1-2 | BPM | Full Brine | 3.766 | 3.606 | 4 |
| B1-5 | BPM | 1:10 Brine | 0.425 | 0.394 | 7 |
| BP-1 | BPM | 1:100 Brine | 0.058 | 0.055 | 6 |

Close examination of the results in FIG. 3 show that, in general, above a Cl⁻ ion concentration of ˜1 M the % differences from the Cl⁻ titration produced values slightly higher than the ICP-MS (runs A4-2, A7-1, B1-3, B1-10, B1-14, B1-16, B1-17, B2-1; median=−8.26%, standard deviation=3.98%, and variance (s_{A})=0.16%) whereas, below a Cl⁻ ion concentration of ˜1 M the % difference from the Cl⁻ titration produced values slightly lower than the ICP-MS (runs A5-3, B1-6, B1-8, B2-3, B2-8, B2-11; median=4.32%, standard deviation=3.23%, and variance (s_{B})=0.10%). The variances from the two sample concentration regions were compared using a two tailed F-test and along with a 95% confidence null hypothesis (Hₒ) that no significant difference in the variances exist (Eq. 3 and 4):

$$\begin{matrix}{F}_{exp} = {s}_{A}^{2} / {s}_{B}^{2} & Equation 3 \\ {H}_{o} \text{:} {s}_{A}^{2} = {s}_{B}^{2} & Equation 4\end{matrix}$$

Pursuant to this, the value for: Fₑₓₚ=(0.0016)²/(0.0010)²=2.2945, and the critical value for F (0.05, 7,5) is 6.853. Because Fₑₓₚ is less than F (0.05, 7, 5) we retain the null hypothesis and have no evidence for a significant difference between s_{A} and s_{B}, which means that the standard deviations of the 14 test samples can be pooled.

Visual examination of the corresponding measurement closeness presented in the FIG. 3 data reveals no significant observed determinate error effecting the results. In order to statistically substantiate this observation, a paired two-tailed t-test method statistical analysis was used with the entire 17 (14 test and 3 standard) % difference sample data set (covering a broad Cl⁻ concentration range between 0.058 M to 3.766 M; median (X) of −1.35% and a 7.27% standard deviation (SD)) along with a 95% confidence null hypothesis that the overall median is not significantly different than 0 (Eq. 5 and 6):

$$\begin{matrix}{t}_{exp} = I μ - XI \sqrt{n} / SD & Equation 5 \\ {H}_{o} \text{:} X = μ & Equation 6\end{matrix}$$

Pursuant to this, the value for: tₑₓₚ=(|0.0−(−0.0135)|√17)/0.0727=0.765, and the critical value for t (0.05, 16) is 2.120. Because tₑₓₚ is less than t (0.05, 16) we retain the null hypothesis and have no evidence for a significant difference between X=μ. Statistical based results from both two tailed F-test and the student's t-test support the use of the ICP-MS measurements for Cl⁻ and BP and the effectiveness of the ICP-MS methodology steps taken to minimize any carry over measurement effects.

Discussions on water and ionic transport diffusion and how it relates to osmotic pressure and osmotic equilibrium are presented herein.

The osmotic pressure, π, of a solution containing n moles of solute particles in a solution of volume V can be determined in rough approximation under dilute (ideal) conditions using the Van't Hoff equation which obeys a form like the ideal-gas law:

$$π V = n R T \qquad Equation 7$$

Where V is the volume of the solution, n is the number of moles of solute, R is the ideal-gas constant, and T is the temperature on the Kelvin scale. Equation 7 can be rewritten as:

$$π = ( n / V ) RT = MRT \qquad Equation 8$$

Where M is the molarity of the solution, expressed as the number of moles of solute per liter of solution, and the units of 7C are in atmospheres (atm). The ICP-MS provides individual ion concentrations in units of ppb which are converted to molarity and then summed together to determine the total solution molarity. According to the Van't Hoff equation, an ideal solution containing 1 mole of dissolved particles per liter of solvent (1 M) at 25° C. will have an osmotic pressure of 22.2 atm

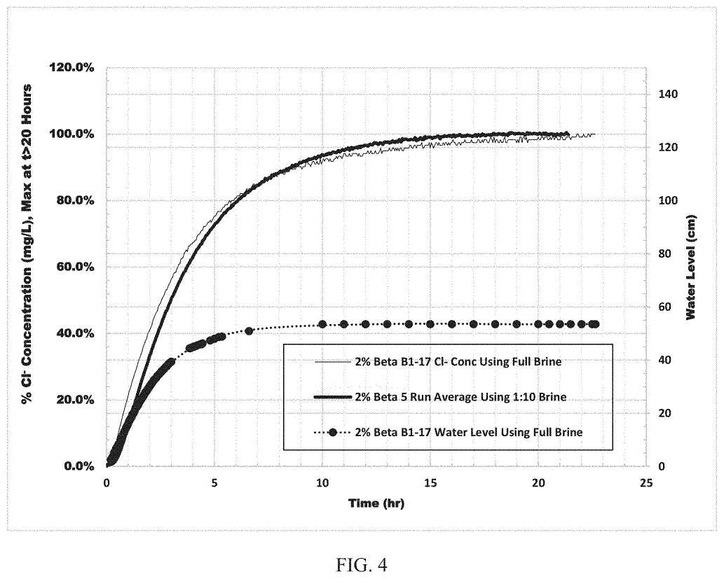

Typical Cl⁻ ion and water transport diffusion measurements across a casted nominal 2% β-chitosan membrane under an equalizing full brine/DI concentration gradient are presented in FIG. 4. The shape of the Cl⁻ ion diffusion across the membrane under test from the concentrated test chamber side into the dilute test chamber side was determined using a Chloride Ion-selective electrode immersed in the dilute test chamber. Data post-processing included normalizing each measured Cl⁻ ion concentration data point to the maximum value measured once equilibrium was reached (t>20 hours). Water transport from the dilute test chamber into the concentrated test chamber was determined through periodic observations of rising water emanating from the concentration test chamber side against a vertically mounted measurement tape with discrete data points measured and a fitted polynomial presented for comparison.

Examination of FIG. 4 reveals a similar curve shape across the β-chitosan membrane for the Cl⁻ ion transport under both high (Full Brine) and low (1:10 Brine) test-cell solution conditions and water transport via net osmotic flow. Extended and varying temporal observations of water transport measurements made for the B1-17 Full Brine run are presented along with the automated B1-17 Cl⁻ measurement run data. Also included in FIG. 4 is a normalized 5-run average obtained from the dilute side of a 1:10 brine concentration/DI test configuration for comparison to the B1-17 Full Brine run data. The smaller fluctuations observed in the 5-run average plot is a function of the 5-run averaging. Select measured values for Cl⁻ ion migration and water transport across both α- and β-chitosan membranes for various conditions are presented in Table 5.

TABLE 5
Select Cl⁻ ion and water transport values across
Alpha (a) and Beta (β) chitosan membranes.

| | | ICP-MS Cl⁻ ion | Average | |
|---|---|---|---|---|
| | Test-Cell | (M) | Maximum Water | |
| Membrane | Solution | Concentration | Level Height | |
| Type | Condition | t > 20 hour | (centimeters) | Run Configurations |
| α-chitosan | Full Brine/DI | 2.142 ± 0.002 | 22.225 | A4-2, A7-1 |
| β-chitosan | Full Brine/DI | 2.371 ± 0.062 | 53.550 | B1-3, B1-10, B1-14, |
| | | | | B1-16, B1-17, B2-1 |
| α -chitosan | 1:10 Brine/DI | 0.166 ± 0.007^{a} | 0 (none observed) | A5-3 |
| β-chitosan | 1:10 Brine/DI | 0.219 ± 0.027 | 5.080 | B1-6, B1-8, B2-3, B2-8, |
| | | | | B2-11 |

^{a}ICP-MS SD used for single measurement.

Examination of the Table 5 results reveal:
An increase in observed water level heights within the manometer with increased initial Cl⁻ concentration (osmotic pressure) under the Full Brine/DI test condition for both the α-chitosan and β-chitosan membranes.
A significant increase in observed water level height for the β-chitosan membrane as compared to α-chitosan membrane (2.4 times) over the same DI/Full Brine solution test condition.

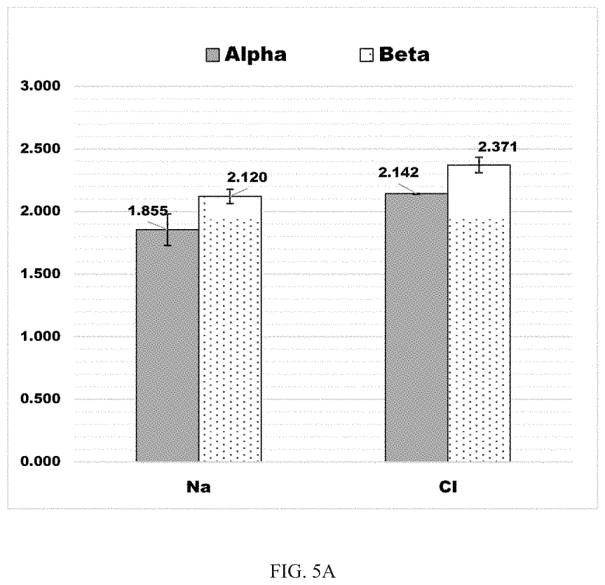

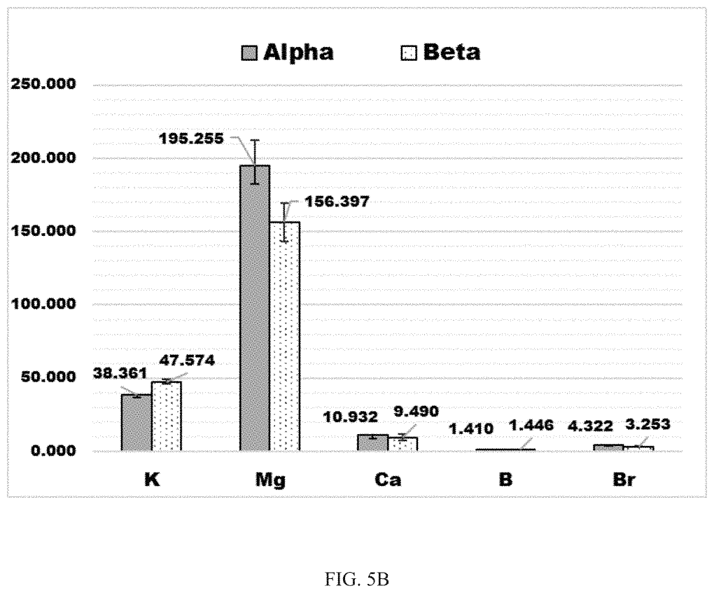

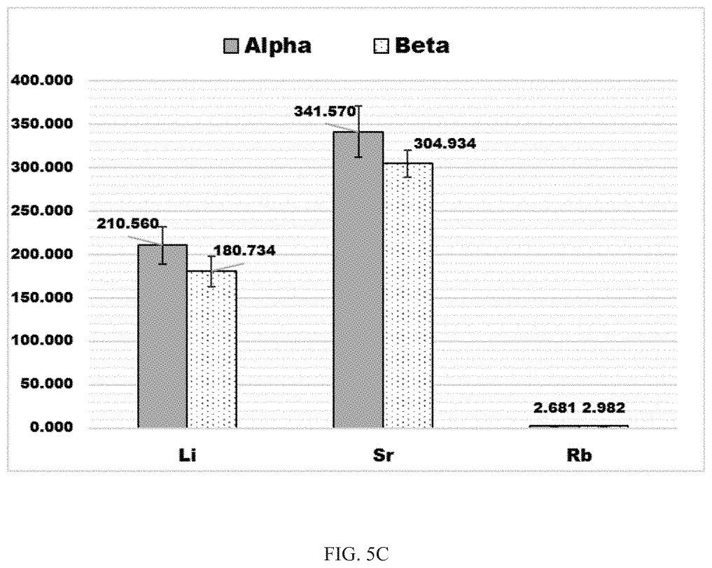

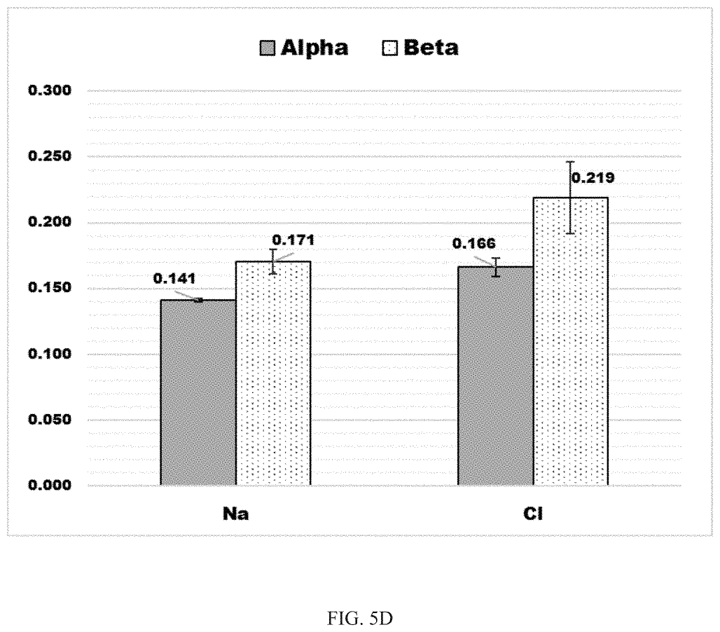

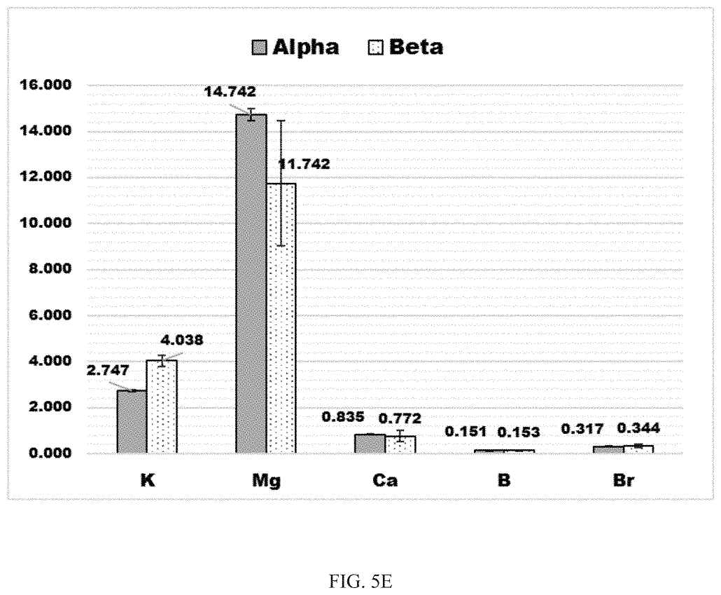

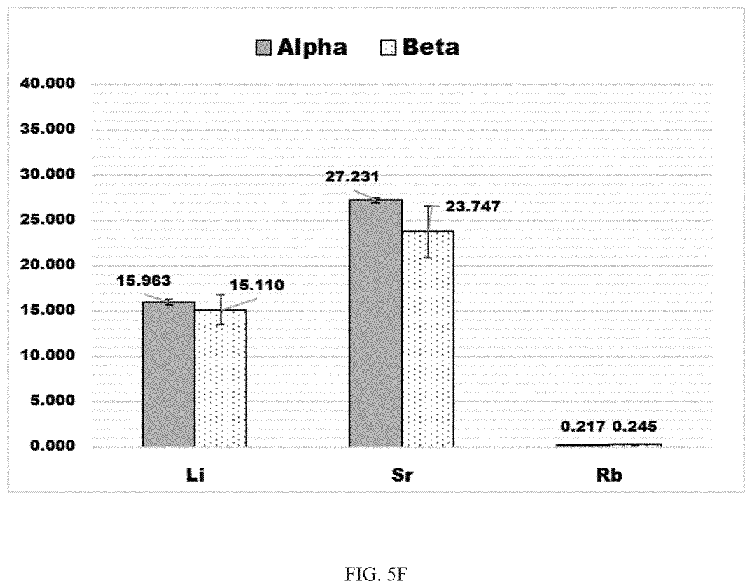

Using select data from the Table 2 run summary and Table 3 measured ICP-MS solution data, cross α-chitosan and β-chitosan membrane ion transport concentrations for Na, Cl, K, Mg, Ca, B, Br, Li, Sr, and Rb were calculated and presented in FIG. 5A-FIG. 5C for Full Brine/DI and FIG. 5D-FIG. 5F for 1:10 Brine/DI. Specific runs used are:
Full Brine/DI; for α-chitosan the average of runs A4-2, A7-1, and for β-chitosan the average of runs B1-3, B1-10, B1-14, B1-16, B1-17, B2-1.
1:10 Brine/DI; for α-chitosan run A5-3, and for β-chitosan the average of runs B1-6, B1-8, B2-3, B2-8, B2-11.

Close examination reveals greater transport in the β-chitosan membrane over the α-chitosan membrane for monovalent Na, Cl, and K ions for both solution concentrations examined. These ions have larger crystal radii and weaker hydration shells which may enable easier detachment from their hydration layer while passing across the β-chitosan membrane with its weaker intermolecular hydrogen bonding between the sheets of parallel chains. Cross membrane ion transport also occurred for the remaining ions examined. However, with the exception of greater transport observed in the α-chitosan membrane over the β-chitosan membrane for the divalent Mg ion in the full brine solution, the closeness and SD overlap prevent an accurate prediction of any overall trend determination. Therefore, it was not possible to determine from the measured data if greater transport would also occur in the α-chitosan membrane over the β-chitosan membrane for the other divalent and trivalent ions tested. However, enough information was obtained to confirm that postulated that β-chitin may possess differing and enhanced performance characteristics than α-chitin with respect to diffusive water flux and ionic transport capabilities.

Using Equation 8 and measured ICP-MS solution data obtained from Table 3, an example calculation of the osmotic pressure and resulting osmotic equilibrium after t>20 hours is presented in Table 6.

TABLE 6
Sample Osmotic Equilibrium Value.

| | | Total | | | Computed | |
|---|---|---|---|---|---|---|
| | Test | Solution | | | Osmotic | Computed Osmotic |
| | Solution | Molarity | Ideal Gas | Temp | Pressure | Pressure of Max. |
| Run | Type | (M) | Constant | (° K) | (atm) | Difference (%) * |
| B1-17 | Full | 4.7097 | 0.08205783 | 296.6 | 114.6 | 60 |
| | Brine/DI | | | | | |
| B1-11 | Full | 4.6499 | 0.08205783 | 296.6 | 113.2 | 60 |
| | Brine/DI | | | | | |

* Full Brine/DI maximum difference between runs A5-1 and B1-2 = 192.5 atm. Slight variation from the expected nominal 50% due to previously mentioned deviation from ideal concentration conditions of the highly concentrated full brine.

Salinity Gradient Power (SGP) generation and/or separation process operations are possible market areas discussed herein for consideration for the chitosan-based membranes. The α-chitosan and β-chitosan membranes of the present invention possess a high water and ion flux permeability, when subjected to a difference in salinity gradient concentration that could be harnessed, as a potential thin film composite (TFC) membrane porous support layer for membrane filtration applications such as Reverse Osmosis (RO) desalinization, for the extraction of economically valuable materials from seawater or highly saline industrial fluids and in the reduction in the saline content of industrial and/or mining fluids for hazardous waste disposal in operations such as desalinization or hydraulic fracturing fracking.

Although numerous SGP solutions have been discussed in the literature, the most often cited technologies focus on variations of two existing water desalting membrane processes; pressure retarded osmosis (PRO) and reverse electrodialysis (RED), where a significant driving force in the industrial development of membranes already exists. PRO and RED utilize the electrochemical properties of solutions of differing saline concentrations (salinity) separated by charged semipermeable ion-exchange membranes.

In PRO, the osmotic process increases the volumetric flow of the high-pressure solution and is the energy transfer mechanism with the gross energy gain per unit membrane area equal to the product of the pressure difference multiplied by the volume flow of fresh water through the membrane. Key to PRO is the cost-effective manufacture of semi-permeable membranes with high water flux permeability and high salt retention (low salt flux).

In RED, anion exchange perm-selective membranes (AEM) and cation exchange perm-selective membranes (CEM) are alternately arranged to form a repeating unit called a cell. The basic RED stack consists of several hundred AEM/CEM cell pairs bound together between end electrodes (anode and cathode) with the driving electromotive force (EMF) in RED provided solely by the salinity concentration gradient. Voltages are generated across each membrane generated from the differences in chemical potentials of the salt ions found in the concentrated and dilute solutions with the back EMF of the transmembrane voltages' additive. Key to RED, also known as a dialytic battery, is the cost-effective manufacture of semipermeable ion-exchange membranes with high perm-selectivity (highly permeable for counter-ions but impermeable to co-ions).

In order to examine the suitability of the chitosan membranes of the present invention for PRO and/or RED operations it is necessary to examine both the water flux and ion transport characteristics from an osmotic process perspective. Examination of FIG. 4 reveals the presence of an osmotic transport flux which leveled off to zero when osmotic equilibrium was reached and examination of FIG. 5A-FIG. 5F reveals the occurrence of cross membrane ion transport. From this, enough detail is available to determine that neither membrane possessed the necessary high salt retention (low salt flux) or high perm-selectivity to either anions or cations required for PRO/RED operations. Therefore, based on the above findings, the use of chitosan membranes would likely not be a good fit for commercial scale PRO or RED SGP operations.

Although the use of the chitosan membranes tested herein would likely not be a good fit for either PRO or RED SGP operations, consideration was given for possible use in an electrochemical concentration fuel cell as part of a fuel cell membrane electrode assembly. Chitosan-based membrane electrolyte have been considered as an alternate candidate in the production of economical fuel cells. As shown in Table 3, both chitosan membranes revealed a nominal loaded membrane voltage potential of 0.6 mV under osmotic equilibrium conditions for either test solution concentration amount @ 100% relative humidity; corresponding to a power density of ˜1.5 nanoWatts/cm² as tested. This contrasts to almost an order of magnitude lower than the ˜8.5 nanoWatts/cm² power density previously measured by the author using Bipolar ion-exchange membranes in the same electrochemical test cell. To put these results into perspective for comparison purposes, according to the European Commission (EC) salinity power estimates, the first commercial 10 MW PRO SGP generation plants would need membranes capable of production of at least 0.6 mW/cm².

A review of the recent literature revealed chitin films prepared with crab shell derived purified chitin using a group of enzymes obtained from Streptomyces griseus. The purified chitin slurry was dispersed in DI water with chitin sheets prepared by suction filtration. The proton conductivity of these films was examined in a traditional H₂/Air fuel cell with the findings that the chitin becomes the electrolyte of the fuel cell in the humidified condition with a typical power density of 1.35 mW/cm² at 100% relative humidity. It was deduced that the relation between the chitin hydrated structure and the proton conduction path formed by the hydrogen bond with the water molecule is significantly important and that these water molecules form hydrogen bonds between the hydroxyl and amino-acetyl groups.

It is important to mention that the electrical conduction method of the traditional H₂/Air fuel cell using proton-conducting cation permselective chitin sheets is different than that of the ˜90% DDA non-ion selective chitosan membranes in an electrochemical fuel cell considered herein. In addition, the partial deacetylation process used to convert chitin to chitosan removes some of the amino-acetyl groups which may contribute to the low energy density observed in the ˜90% DDA chitosan membranes evaluated herein. While it is possible that the energy density output of the electrochemical fuel cell will improve slightly upon using chitosan membranes with a lower % DDA value, it is unlikely that the necessary large-scale improvements in energy density from nanoWatts/cm² to mW/cm² for utility-scale generation purposes will be realized going from ˜90% DDA to the ˜50% DDA lower limits for chitin/chitosan conversion.

However, the chitosan-based membranes of the present invention having a slightly lower % DDA value may be used in energy scavenging applications including batteries, capacitors and fuel cells for uses inside the human body where natural ion-exchange conditions and low across membrane voltages/currents exist.

Typical measurements of dry thickness and % Gel Swelling Index (GSI) for new/used membranes (using Equation 10 to follow), are presented as follows:
Shrimp (α) New: Thickness=0.07112 mm; Wet Weight=350 g; Dry Weight=150 g; Computed % GSI=1.33.
Shrimp (α) Used: Thickness=0.06858 mm; Wet Weight=1,350 g; Dry Weight=530 g; Computed % GSI=1.55.
Squid (β) New: Thickness=0.10160 mm; Wet Weight=720 g; Dry Weight=320 g;

Computed % GSI=1.25.
Squid (β) Used: Thickness=0.05588 mm; Wet Weight=660 g; Dry Weight=280 g; Computed % GSI=1.36.

Examination reveals that although the dry thickness of the new β-chitosan membrane was more than for the new α-chitosan membrane, the % GSI value for the new β-chitosan membrane was less than the new α-chitosan membrane. Compare that to the used β-chitosan membranes which was lower in both dry thickness and % GSI than a used α-chitosan membrane. Owing to changes in the crystalline sheet orientation/lattice structure, degree of hydration, or the presence of any remaining intercalated water/ions. This result is also supported by visual/textual observations in which the used β-chitosan membrane physically felt thinner than and was not as stiff as when new.

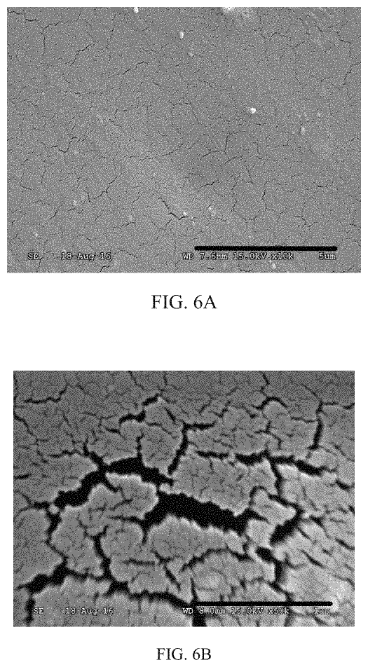

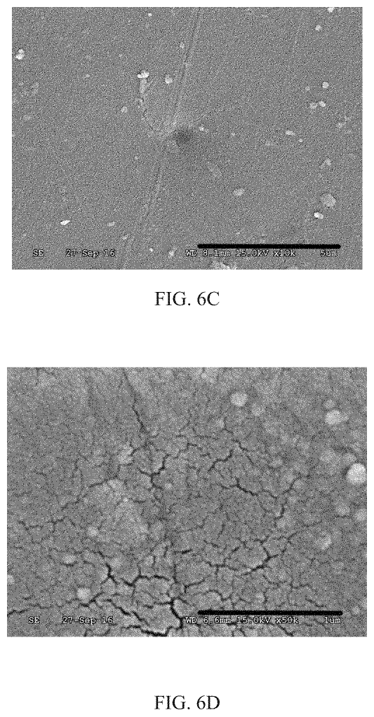

SEM 10,000× (low resolution) and 50,000× (high resolution) images from a new piece of α-chitosan membrane are presented in FIG. 6A and FIG. 6B, respectively. SEM images from a new piece of β-chitosan membrane under a magnification of 10,000× and 50,000× are presented in FIG. 6C and FIG. 6D, respectively. Examination of the 10,000× images reveals general surface cracking present in both images with the α-chitosan membrane exhibiting more. Examination of the higher 50,000× resolution images reveals more detail of the crack structure and patterns. In neither case was a pore like structure observed at either magnification in either imaged membrane sample. Although not examined directly, the increased diffusive water flux and ionic transport capabilities noted herein for the β-chitosan as compared to the α-chitosan membrane could be attributed to weaker intermolecular hydrogen bonding found in β-chitosan between the sheets of parallel chains.

The 50,000× α-chitosan image with the larger cracks displayed was very unstable under the electron beam with the crack expansion occurring during observation. It is conjectured that the thinner α-membrane is breaking up under the hot electron beam as evidenced by the cracks being wider in the image center where the beam is more concentrated. This crack expansion was not observed on the 50,000× β-chitosan sample when imaged. No similar expansion was noted during observation on either of the 10,000× samples but any minor expansion would be harder to see at 10,000× vs. 50,000× so it is difficult to determine if the differences in the width of the crack between the two 10,000× images are real differences or reflect an instability problem (heating) caused by the differences in the membrane thickness.

Physicochemical and novel colligative investigations of alpha (a) and beta ((3) chitosan membranes were conducted which confirmed that β-chitin may possess differing and enhanced performance characteristics than α-chitin with respect to diffusive water flux and ionic transport capabilities. The tested membranes possessed high water and ion flux permeability characteristics that could foster new market developments into separation process operations such as those used in the extraction of economically valuable materials from seawater or highly saline industrial fluids, the reduction in the saline content of mining fluids during dewatering, or during hazardous waste treatment and disposal operations.

The following paragraphs describe the experimental material and methods in accordance with various embodiments of the present invention.

Chitosan membranes were prepared from two commercially obtained sources; shrimp shells from Sigma-Aldrich Corporation, USA (CAS 9012-76-4; Sigma-Aldrich P/N C3646-25G) and squid pens from GTC Bio Corporation, Qingdao, China (SGC-2). The shrimp-based product was obtained as a white powder with a vendor supplied DDA value of 88%, and the squid-based product was obtained as a white powder with a vendor supplied DDA value of 91.7%. The viscosity of a solution of 1% chitosan (by weight) in 1% (by volume) aqueous acetic acid was provided by the vendor as 232 centipoise (cP) for the shrimp-based chitosan and ≤300 cP for the squid-based chitosan.

Reagent grade chemicals obtained and used include: glacial acetic acid (C₂H₄O₂), glycerol (C₃H₈O₃), sodium hydroxide (NaOH), nitric acid (HNO₃), potassium bromide (KBr), silver nitrate (AgNO₃), and sodium acetate (NaC₂H₃O₂). Synthetic seawater was prepared using Instant Ocean® Sea Salt (Spectrum Brands, USA) dissolved in Milli-Q ultrapure (18.2 MΩcm) water from a Millipore purification system.

Fourier-Transform Infrared (FTIR) spectrometry was used to determine the DDA and to examine any observed changes in intra-sheet or inter-sheet hydrogen bond characteristics of the α- and β-chitosan samples. % DDA results were then compared to the vendor supplied values. Chitosan powder was mixed with KBr (1:15) and pressed into a pellet. The spectrum was collected in transmission mode over a 400-4000 cm⁻¹ range by placing the pellet in the beam path of a FTIR spectrometer (Nicolet Magna, USA). A total of 256 scans at 2 cm⁻¹ resolution were averaged and corrected for background CO₂ and water in a nitrogen purged compartment.

Aqueous GPC/SEC testing was conducted on a Viscotek TDA305 and GPCmax system, running OmniSEC 4.6.2 analysis software and configured for GPC/SEC triple detection analysis. The GPC/SEC system was equipped with a temperature-controlled oven housing four columns and three detectors: Refractive Index (RI), Right Angle and Low Angle Light Scattering (RALS/LALS), and a four-Capillary Differential Viscometer. In Triple Detection SEC/GPC, the RI detector is employed to calculate concentration, refractive index increment (dn/dc), and injection recovery. Light scattering provides absolute molecular weight while the viscometer delivers intrinsic viscosity (η), hydrodynamic radius (Rₕ), and conformational and structural parameters. SECs used were:
PolyAnalytik AquaGEL® GPC Column-206, Exclusion Limit: >20×10⁶ Da PEO,
PolyAnalytik AquaGEL® GPC Column-204, Exclusion Limit: >1×10⁶ Da PEO,
PolyAnalytik AquaGEL® GPC Column-203, Exclusion Limit: >1×10⁵ Da PEO,
PolyAnalytik AquaGEL® GPC Column-202.5, Exclusion Limit: >1×10³ Da PEO.

Standards at a concentration of 3 mg/ml and a 0.152 mL/g do/dc consisted of:
Calibration: Pullulan Narrow 50 KDa (PULL 50K, Lot #PATD-PUL 50K-5),
Verification: Pullulan Broad 30 KDa (PULL 30K, Lot #PATD-PBR 30K),
Verification: Pullulan Narrow 10 KDa (PULL 10K, Lot #PATD-PUL 10K).

The mobile phase selected for use consisted of 0.1 M acetic acid and 0.3 M sodium nitrate mixture in HPLC grade water. Chitosan powder samples were dissolved in the mobile phase at a concentration of approximately 4.0 mg/mL (4.40 for Shrimp and 4.35 for Squid) and filtered through a 0.22 μm PES membrane syringe filter prior to injection. Injection parameters include: 100 μL injection, column temperature: 35° C., flow rate: 0.7 mL/min, run time: 60 minutes. Run summary consisted of triplicate runs with the verification standards injected at the end of the sample injections to verify detector calibrations.

The chitosan membrane solution was prepared by combining DI water, chitosan, and glacial acetic acid (casting solvent) in a 200 ml beaker and placed on a magnetic stirrer plate with moderate stirring for 48 hours at room temperature until thoroughly dissolved and clear. The solution was then heated to 60° C. and glycerol added as a plasticizer. After mixing for 15 minutes, the solution was removed from the heat for 30 minutes, followed by 1 hour under a 15-inch Hg vacuum to de-gas. After setting for 2 hours outside the vacuum chamber at ambient laboratory conditions (nominally 20-25° C., 40-55% RH air, standard pressure), a single membrane was cast by pouring the chitosan/glycerol solution onto a leveled 20.3×27.9 cm (8×11 inch) glass plate framed with strips of 0.635 cm (¼ inch) thick acrylic (methyl methacrylate). Water and acetic acid evaporation occurred under ambient conditions for at least 3 days under a ventilated flume hood, scored in half along the short side, and peeled from the casting surface. Since the as-cast membranes are completely soluble in water at this point, the dried membranes were placed in a 2% NaOH solution (10.05 grams of NaOH in 500 ml of DI water) for 30 minutes, and then washed extensively with DI water until neutral pH obtained. The neutralized and now insoluble membranes were stored in DI water until they were placed inside the concentration cell test fixture at the commencement of the water flux and ionic transport diffusion experiments.

The laboratory test apparatus consisted of a single, side-by-side concentration cell of cubic design with nominal outer dimensions of 10 cm×10 cm×7 cm, connected to a Vernier LabPro® sensor interface for remote data collection using Logger Pro 3 data-collection software. The test cell consists of end plates, electrodes made from #40 wire silver (Ag) mesh, two symmetrical test chambers (a concentrated solution side and a dilute solution side) and a single chitosan membrane under test, all separated by gaskets for sealing the cell and containing the liquid within. Inner test chamber nominal dimensions were 7 cm×7 cm×2.5 cm. A detailed description of the concentration test cell operation can be found in previous works by the inventor.

During each run, “loaded” cell potential voltage measurements were logged across the electrodes and a 500-ohm (nom.) resistor connected in parallel. Cumulative multi-species ion-transfer across the membrane was determined using ICP-MS analysis of samples selectively removed from the test cell at run completion. Visual evidence of the migration of water moving across the membrane from the dilute test chamber to the concentrated test chamber under direct osmotic flow was observed at ambient laboratory conditions. To accomplish this a manometer, constructed out of a piece of 0.635 cm (¼ inch) ID Tygon® tubing, was attached to the exit port of the concentrated solution side of the test chamber and secured vertically above the test cell with the other end of the tube open to ambient laboratory conditions. The exit port tube was examined for the presence of water and when observed its incremental height change recoded as it rose vertically in the tube until it stopped when isotonic (equal osmotic pressure) conditions were obtained in each chamber side.

Aqueous samples obtained from the concentration cell were diluted by a factor of 10-1000 with 2% nitric acid, except where concentrations were below the lowest calibration standard, in which case no dilution was performed. A small amount of internal standard solution containing Be, Sc, Ge, and Y was added to each sample in order to correct for instrumental drift during analysis. Prepared samples were analyzed with an Agilent 7500cx ICP-MS equipped with a concentric micro mist nebulizer, a double-pass quartz spray chamber, and a High Matrix Introduction (HMI) accessory. Samples were introduced into the ICP-MS via Tygon® tubing using an ASX-500 auto sampler. An external 6-point calibration curve was used to determine elemental concentrations. A 2% nitric acid solution was used as a blank and to rinse the instrument between samples. Samples were analyzed for Li, Na, Mg, K, Ca, Rb, and Sr at lower dilution factors (10 or 100). Because of their potential for carry over, Cl, B, and Br were analyzed separately at higher dilution factors (100 or 1000), along with an extended rinse time using both a 5% nitric acid solution and a 2% nitric acid solution. Additionally, a blank was analyzed after every standard and sample to minimize any carry over. Anions Cl⁻ and BP are typically not measured with the ICP-MS but because of their relative importance as major seawater constituents, Cl⁻ 55.06% and Br⁻ 0.173% total salt in seawater, their inclusion was important to this analysis. Evaluation of the published literature revealed the use of ICP-MS for the determination of BP and analysis of Cl⁻ from sweat for use in the diagnosis of cystic fibrosis. Because of the high concentrations of Cl⁻ present in the samples, a separate Cl⁻ ion titration was made on each test sample for ICP-MS comparison to ensure the validity of the ICP-MS Cl⁻ measurement method and resulting values.

Chloride ion concentrations were determined by potentiometric titration with silver nitrate (AgNO₃) using a converted dual electrode pH meter with agitation of the immersed electrodes achieved using a 120S Fisher Scientific magnetic stirrer. During titration a Fluke 8062A True RMS multi-meter was used to detect the change in potential between a Thermo Orion 9416BN Silver/Sulfide Half-Cell Electrode and a Thermo Orion 900200 Double Junction Reference Electrode. During the titration, the two electrodes were connected to the pH meter via the terminals used for the glass electrode and calomel electrode normally used in pH measurements.

When AgNO₃ is slowly added to the Cl⁻ ion containing synthetic seawater test sample, an insoluble precipitate of silver chloride (AgCl) forms according to Equation 9:

$${Ag}^{+} ( aq ) + {Cl}^{-} ( aq ) \to AgCl ( s ) \qquad Equation 9$$

The end point of the titration occurs when all the chloride ions are precipitated and is determined by the multi-meter reading at which the greatest change in voltage has occurred for a small and constant added increment of AgNO₃.

Certain materials, including many biological membranes are semipermeable, meaning that when they come in contact with a solution, they selectively allow the passage of certain molecules or ions to cross the membrane while blocking others. Osmosis or osmotic flow refers to the net diffusional movement of solvent molecules across a semipermeable membrane under the effect of a concentration gradient toward the solution with the higher solute concentration. The only way to stop osmosis is to raise the hydrostatic pressure on the concentrated solution side of the membrane and achieve osmotic equilibrium. This can be done through the application of a suitable amount of external pressure, by letting the pressure build up via osmotic flow into an enclosed region, or in the case of our test chamber through the pressure difference resulting from the unequal vertical liquid height in the concentrated side exit port tube. The pressure required to achieve osmotic equilibrium and stop the net osmotic flow is known as the osmotic pressure.

Osmotic pressure along with boiling point elevation, freezing point depression, and vapor pressure depression are known as colligative properties that arise solely from the dilution of a solvent by non-volatile solutes. The word colligative comes from the Latin colligatus meaning to bind together. Colligative properties are physical properties of solutions that depend almost entirely on the total concentration of the dissolved species (ions or molecules) and not on the nature nor identity of the species present.

Dry membrane thickness and Gel Swelling Index (GSI) measurements were obtained from new/used pieces of the casted α- and β-chitosan membranes. Because of limited source availability, these pieces were obtained from the same manufactured batch but were not the same piece. The “used” pieces were the actual membranes used in the concentration test cell, subject to both transmembrane water and ion-transport, whereas the “new” pieces were batch remnants that were only exposed to DI water. New/used dry membrane thickness and GSI measurements were initiated by placing samples of each membrane into a desiccator and weighing them daily until there was no measurable change in weight as compared to the prior measurement. After which a final weight was recorded, as well as, a dry thickness measurement using a dial caliper. The samples were then placed in DI water for 24 hours, after which they were removed, wiped with a dry tissue, and weighed. This procedure continued until there was no measurable change in weight as compared to the prior measurement. After which a final weight was recorded and the GSI computed using Equation 10.

$$GSI = [ ( wet weight - dry weight ) / ( dry weight ) ] * 100 \% \qquad Equation 10$$

Comparable visual evidence of surface deformation and overall shrinkage was present after drying, especially in the “used” pieces.

A small sample from each of the cast membranes was mounted on an aluminum stub and coated with a thin layer of gold/palladium metal. It was then imaged at two different magnifications (10,000× and 50,000×) using a Hitachi S-3500N variable pressure scanning electron microscope (SEM) with a resolution of 3 nm.

As such, the present invention provides for a physicochemical and colligative investigation of α-chitosan and β-chitosan membranes that was conducted with a focus on concentration gradient driven water flux and ion transport for SGP generation and separation process operations. Physicochemical and colligative comparisons are presented to provide necessary details in order to foster new market developments and continued improvements in the responsible bio-waste management of this valuable marine resource.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A membrane comprising chitosan, the membrane having a water and ion flux permeability under a salinity concentration gradient.

2. The membrane of claim 1, wherein the water and ion flux permeability is a high water and ion flux permeability under the salinity concentration gradient

3. The membrane of claim 1, wherein the water and ion flux permeability is a low water and ion flux permeability under the salinity concentration gradient.

4. The membrane of claim 1, wherein the chitosan has a degree of deacetylation (DDA) greater than about 90%.

5. The membrane of claim 1, wherein the chitosan is selected from α-chitosan, β-chitosan and γ-chitosan.

6. The membrane of claim 1, wherein the membrane comprises an approximately 2% composition of chitosan.

7. The membrane of claim 1, wherein the membrane is non-ion selective.

8. The membrane of claim 1, wherein the membrane is a micro porous support layer of a thin film composite (TFC) membrane for Reverse Osmosis (RO) desalinization.

9. The membrane of claim 8, wherein economically valuable materials are recovered from a highly concentrated saline solution seawater or another highly saline industrial fluid under the salinity concentration gradient.

10. The membrane of claim 9, wherein the highly concentrated saline solution is selected from seawater and highly saline industrial fluids.

11. The membrane of claim 7, wherein the saline content of a highly concentrated saline solution is reduced.

12. The membrane of claim 9, wherein the highly saline concentrated solution is selected from an industrial fluid, a mining fluid for hazardous waste disposal, and a hydraulic fracking of water.

13. The membrane of claim 3, wherein the membrane is part of a dialytic membrane electrode assembly for a Salinity Gradient Power (SGP) energy generation systems.

14. A method for performing Reverse Osmosis (RO) of saltwater, the method comprising, positioning a thin film composite (TFC) membrane comprising chitosan as a porous support layer under a salinity concentration gradient, wherein the chitosan has a degree of deacetylation (DDA) greater than about 90% to perform RO of the saltwater.

15. The method of claim 14, wherein performing RO desalinates the saltwater.

16. The method of claim 14, wherein performing RO accumulates one or more economically valuable materials from the saltwater.

17. The method of claim 14, wherein the saltwater is selected from seawater and other highly saline industrial fluids.

18. The method of claim 14, wherein the chitosan is selected from α-chitosan, β-chitosan and γ-chitosan.

19. The method of claim 14, wherein the membrane comprises an approximately 2% composition of chitosan.

20. A method for Salinity Gradient Power (SGP) generation, the method comprising, positioning a semi-permeable ion selective membrane comprising chitosan under a salinity concentration gradient to generate power, wherein the membrane has a low ion flux permeability under the salinity concentration gradient.

21. The method of claim 20, wherein the chitosan is selected from α-chitosan, β-chitosan and γ-chitosan.

22. The method of claim 20, wherein the membrane comprises an approximately 2% composition of chitosan.
